(19) United States
(12) Patent Application Publication
(10) Pub. No.: US 2021/0035136 A1
(43) Pub. Date: Feb. 4, 2021

(54) TRAFFIC DETERMINATION

(71) Applicant: Advanced New Technologies Co., Ltd., George Town (KY)

(72) Inventors: Hongbo Cai, Hangzhou (CN); Kaiming Huang, Hangzhou (CN); Xiaodong Zeng, Hangzhou (CN)

(73) Assignee: Alibaba Group Holding Limited, George Town (KY)

(21) Appl. No.: 16/803,317

(22) Filed: Feb. 27, 2020

Related U.S. Application Data
(63) Continuation of application No. PCT/CN2020/072035, filed on Jan. 14, 2020.

(30) Foreign Application Priority Data
Aug. 2, 2019 (CN) 201910711394.4

(51) Int. Cl. G06Q 30/02; G06F 21/60

(52) U.S. Cl. CPC G06Q 30/0205; G06F 21/602

(57) ABSTRACT

A computer-implemented method includes: obtaining, by a detection device, first device information of a first set of devices detected in a target area using a first communication mode; determining, based on the first device information, a first quantity of devices in the target area; determining, based on second device information of a second set of devices, a verification coefficient, the second set of devices being detected in the target area using a second communication mode; and calculating, based on the first quantity of devices and a verification coefficient, a measure of real-time human traffic in the target area.

### CROSS-REFERENCE TO RELATED APPLICATIONS

This application is a continuation of PCT Application No. PCT/CN2020/072035, filed on Jan. 14, 2020, which claims priority to Chinese Patent Application No. 201910711394.4, filed on Aug. 2, 2019, and each application is hereby incorporated by reference in its entirety.

### TECHNICAL FIELD

The present disclosure relates to the field of information technologies, and in particular, to human traffic statistical methods and devices.

### BACKGROUND

A fundamental issue of traffic monetization and operation strategy optimization in offline business scenarios is to determine a size of effective human traffic, so as to carry out a series of downstream traffic monetization operations such as sales, billing, and product deployment.

### SUMMARY

An object of the present disclosure is to provide human traffic statistical methods and devices, to resolve the existing problem of inaccurate device-based human traffic statistics.

According to a first aspect of the present disclosure, a human traffic statistical method is provided, including: obtaining first device information of devices detected in a first communication mode in a target area; determining a first quantity of the devices in the target area based on the first device information; and calculating a second quantity of the devices in the target area based on the first quantity and a verification coefficient, where the verification coefficient is obtained by detecting second device information in a second communication mode; and using the second quantity as real-time human traffic in the target area.

Further, the method of the present disclosure further includes: obtaining first historical device information of the devices detected in the target area in the first communication mode; obtaining second historical device information of the devices detected in the target area in the second communication mode; and calculating the verification coefficient based on the first historical device information and the second historical device information.

Further, according to the method of the present disclosure, the steps of calculating the verification coefficient based on the first historical device information and the second historical device information further includes: determining a third quantity of the same device identifiers in the first historical device information and the second historical device information based on the first historical device information and the second historical device information; and calculating the verification coefficient based on the third quantity and a fourth quantity extracted from the second historical device information.

Further, according to the method of the present disclosure, the step of obtaining first historical device information of the devices detected in the target area in the first communication mode includes: obtaining the first historical device information of the devices detected in the target area in a same period in the previous cycle in the first communication mode; and the step of obtaining second historical device information of the devices detected in the target area in the second communication mode includes: obtaining the second historical device information of the devices detected in the target area in the same period in the previous period in the second communication mode.

Further, according to the method of the present disclosure, the step of determining a first quantity of the devices in the target area based on the first device information includes: counting, based on the first device information, a fifth quantity of the devices detected at least twice within a predetermined period; and de-weighting the devices in the target area based on the first quantity, to determine the first quantity of the devices in the target area.

Further, according to the method of the present disclosure, after the step of obtaining second historical device information of the devices detected in the target area in the second communication mode, the method includes: encrypting a device address in the second history device information.

According to a second aspect of the present disclosure, a human traffic statistics device is provided, including: an acquisition module, configured to obtain first device information of devices detected in a first communication mode in a target area; a determining module, configured to determine a first quantity of the devices in the target area based on the first device information; and a calculation module, configured to: calculate a second quantity of the devices in the target area based on the first quantity and a verification coefficient, where the verification coefficient is obtained by detecting second device information in a second communication mode; and use the second quantity as real-time human traffic in the target area.

Further, according to the device of the present disclosure, the acquisition module includes a first acquisition submodule and a second acquisition submodule; and the calculation module includes a calculation submodule; where the first acquisition submodule is configured to obtain first device information of devices detected in a first communication mode in the target area; the second acquisition submodule is configured to obtain second device information of devices detected in a second communication mode in the target area; and the calculation submodule is configured to calculate the verification coefficient based on the first historical device information and the second historical device information.

Further, in the device of the present disclosure, the calculation submodule is configured to: determine a third quantity of the same device identifiers in the first historical device information and the second historical device information based on the first historical device information and the second historical device information; and calculate the verification coefficient based on the third quantity and a fourth quantity extracted from the second historical device information.

Further, according to the device of the present disclosure, the first acquisition submodule is specifically configured to: obtain the first historical device information of the devices detected in the target area in a same period in the previous cycle in the first communication mode; and the second acquisition submodule is specifically configured to: obtain the second historical device information of the devices detected in the target area in the same period in the previous period in the second communication mode.

Further, according to the device of the present disclosure, the determining module is further configured to: count, based on the first device information, a fifth quantity of the devices detected at least twice within a predetermined period; and de-weight the devices in the target area based on the first quantity, to determine the first quantity of the devices in the target area.

Further, the device of the present disclosure further includes: an encryption module, configured to encrypt a device address in the second history device information.

According to a third aspect of the present disclosure, a storage medium is provided, where the storage medium stores computer program instructions, and the computer program instructions are executed according to the method of the present disclosure.

According to a fourth aspect of the present disclosure, a computing device is provided, including: a memory, configured to store computer program instructions, and a processor, configured to execute the computer program instructions, where when the computer program instructions are executed by the processor, the computing device is triggered to perform the method of the present disclosure.

According to the human traffic statistical method and device provided in the present disclosure, the first device information of the devices is detected in the first communication mode; the second quantity of the devices in the target area is obtained through calculation based on the verification coefficient and the first quantity of the devices in the target area that is obtained based on the first device information; and the second quantity is used as the real-time human traffic of the target area, where the verification coefficient is obtained based on the second device information of the devices detected in the second communication mode. In the technical solutions of the implementations of the present disclosure, the first quantity is detected in the first communication mode, the first quantity is verified by using the verification coefficient, and the verification coefficient is obtained based on the second device information obtained in the second communication mode. Therefore, the quantity of the devices in the target area can be detected more accurately in the first communication mode, so that the obtained real-time human traffic in the target area is more accurate.

### BRIEF DESCRIPTION OF DRAWINGS

Other features, objects and advantages of the present disclosure will become more clear by reading the detailed description of the non-limiting implementations with reference to the following figures:

FIG. 1 is a schematic flowchart illustrating a human traffic statistical method, according to an implementation of the present disclosure;

FIG. 2 is a schematic diagram illustrating an application scenario of a human traffic statistical method, according to an implementation of the present disclosure; and

FIG. 3 is a schematic structural diagram illustrating a human traffic statistical device, according to an implementation of the present disclosure.

Like or similar reference numerals in the accompanying drawings represent identical or similar components.

### DESCRIPTION OF IMPLEMENTATIONS

The present disclosure is described below with reference to the accompanying drawings.

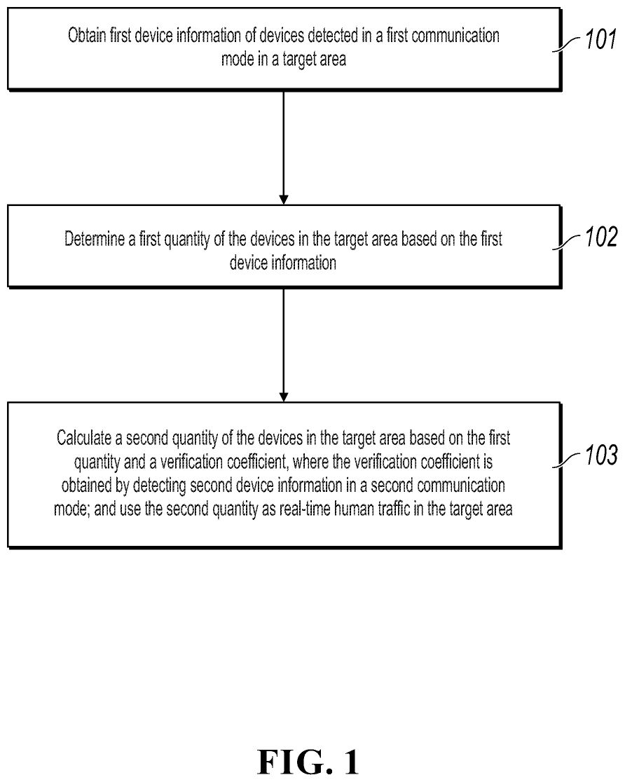

FIG. 1 is a schematic flowchart illustrating a human traffic statistical method, according to an implementation of the present disclosure. As shown in FIG. 1, the human traffic statistical method provided in some implementations of the present disclosure includes:

Step S101: Obtain first device information of devices detected in a first communication mode in a target area.

Step S102: Determine a first quantity of the devices in the target area based on the first device information.

Step S103: Calculate a second quantity of the devices in the target area based on the first quantity and a verification coefficient, where the verification coefficient is obtained by detecting second device information in a second communication mode; and use the second quantity as real-time human traffic in the target area.

Here, the first communication mode can be Wi-Fi, and the second communication mode can be Bluetooth; or the first communication mode can be radio frequency identification (RFID), and the second communication mode can be infrared. In summary, the first communication mode and the second communication mode are different communication modes, and are used to connect a corresponding detection device based on the communication mode, so that the corresponding detection device can detect device information in the target area based on different communication modes.

Here, the device information includes at least a device identifier; and determining a first quantity of the devices in the target area based on the first device information can include: counting the quantity of device identifiers based on the device identifier in the first device information, to obtain a first quantity of devices in the target area.

Because the first device information of the devices is detected only in the first communication mode, the first quantity obtained based on the first device information may not completely represent the human traffic in the target area. Therefore, the verification coefficient is also used in some implementations to verify the first quantity. Here, the verification coefficient takes into consideration the second device information detected based on the second communication mode.

Compared with the existing technology, because in the human traffic statistical method provided in some implementations of the present disclosure, the first quantity is detected in the first communication mode, the first quantity is verified by using the verification coefficient, and the verification coefficient is obtained based on the second device information obtained in the second communication mode. Therefore, the quantity of the devices in the target area can be detected more accurately in the first communication mode, so that the obtained real-time human traffic in the target area is more accurate.

Optionally, the human traffic statistical method provided in some implementations of the present disclosure further includes: obtaining first historical device information of the devices detected in the target area in the first communication mode; obtaining second historical device information of the devices detected in the target area in the second communication mode; and calculating the verification coefficient based on the first historical device information and the second historical device information.

Here, the historical device information is used to represent device information of the devices in the target area obtained before the current time. In other words, the verification coefficient can be pre-calculated, and the verification coefficient only needs to be applied when the human traffic in the target area is measured at a current time, so that accuracy and efficiency of the human traffic statistics collection are improved.

Specifically, the step of calculating the verification coefficient based on the first historical device information and the second historical device information further includes: determining a third quantity of the same device identifiers in the first historical device information and the second historical device information based on the first historical device information and the second historical device information; and calculating the verification coefficient based on the third quantity and a fourth quantity extracted from the second historical device information.

For example, P_{wifi} indicates the probability at which a person is detected by a Wi-Fi probe when passing by the target area (the Wi-Fi probe sampling rate);

n_{wifi&ble} indicates the quantity of persons that are detected by the Wi-Fi probe and that report Bluetooth beacons;

n_{wifi} indicates the quantity of persons that are detected by the Wi-Fi probe.

n_{ble} indicates the quantity of persons that report Bluetooth beacons.

P_{wifi}=n_{wifi&ble}/n_{wifi}.

Here, n_{wifi&ble} can be understood as the determined third quantity; n_{ble} can be understood as the fourth quantity; and P_{wifi} can be understood as the verification coefficient.

Optionally, the step of obtaining the first historical information of the devices detected in the first communication mode in the target area includes: obtaining the first historical device information of the devices detected in the target area in a same period in the previous cycle in the first communication mode; and the step of obtaining second historical device information of the devices detected in the target area in the second communication mode includes: obtaining second historical device information of the devices detected in the target area in the second communication mode.

Here, the period can be one month, one week, one day, etc.; and the corresponding time segment can be several days, one day, one hour, etc. By counting the data in the same time segment of the previous cycle, the related data in the same time segment of the current cycle can be obtained accurately, which provides reference for the counting for the same time segment of the current cycle, thereby making the human traffic statistics more accurate.

Optionally, the step of determining a first quantity of the devices in the target area based on the first device information includes: counting, based on the first device information, a fifth quantity of the devices detected at least twice within a predetermined period; and de-weighting the devices in the target area based on the first quantity, to determine the first quantity of the devices in the target area.

Here, counting, based on the first device information, a fifth quantity of the devices detected at least twice within a predetermined period includes: determining, based on the device identifier in the first device information, a quantity of times that the device with the same device identifier is detected within the predetermined period; when the quantity of times is greater than or equal to 2, counting the device with the same device identifier for the second time; and accumulating the statistics to obtain the fifth quantity.

De-weighting the devices in the target area based on the first quantity, to determine the first quantity of the devices in the target area includes: determining, based on the first device information, the quantity of devices detected, and subtracting the fifth quantity from the quantity of the devices detected to obtain the first quantity.

Therefore, in some implementations, the quantity of devices appearing in the target area twice or more times within a predetermined period is only calculated as 1, which improves the accuracy of human traffic statistics.

Optionally, after the step of obtaining second historical device information of the devices detected in the target area in the second communication mode, the method includes: encrypting a device address in the second history device information.

The encryption may include: performing a numerical mapping on the device address; and may further include: constructing a dictionary for the device address, where the dictionary includes a correspondence between the device address and time.

As such, the device address detected in the second communication mode is encrypted, and only the quantity of pieces of the second history information needs to be provided to the system, which can prevent the system from detecting the privacy related to the device address information in the first communication mode. In addition, construction of the dictionary can increase query efficiency and compression rate to save space.

The following describes the human traffic statistical method provided in the previous implementation with reference to a specific implementation.

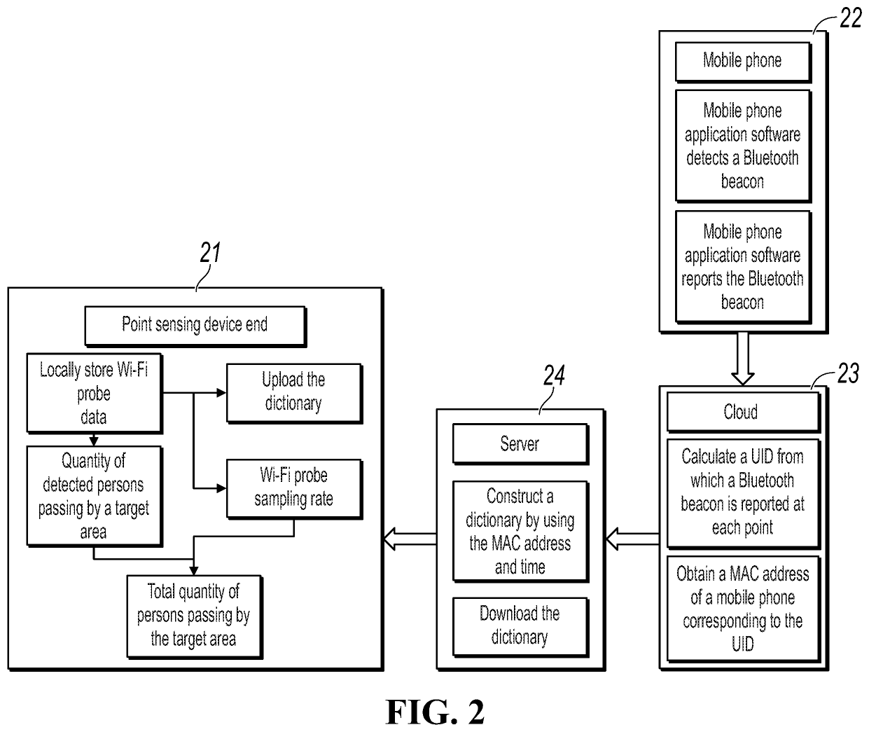

FIG. 2 is a schematic diagram illustrating an application scenario of a human traffic statistical method, according to an implementation of the present disclosure. As shown in FIG. 2, a point sensing device end 21 can be understood as a detection device that is deployed in the target area for detection in the target area; and a mobile phone 22 can be understood as a mobile device used in the target area.

In some implementations, a cloud 23 and a server 24 are used to store and calculate the user identification (UID) of the Bluetooth beacon reported at each point, obtain a MAC address of the mobile phone corresponding to the UID, construct a dictionary by the server 24 based on the correspondence between the MAC address and time, and deliver the dictionary to the point sensing device end 21 by the server 24.

Specifically, the data collection phase includes: collecting the device information that is collected by the Wi-Fi probe and that is reported by the device; collecting Bluetooth beacon information reported by a mobile phone application; and collecting the correspondence between the UID and the MAC address. The sample rate calculation phase (that is, the verification coefficient calculation phase described in the previous implementation) includes: perform computing, by cloud 23, on the Bluetooth Beacon information that is reported by the mobile phone application software of the previous day, encrypting the corresponding MAC address, then establishing a dictionary structure, and finally delivering the dictionary structure to the point sensing device end 21; and calculating, by using a statistical method, the probability that a person is detected by the Wi-Fi probe when passing by the target area within the previous day (that is, the verification coefficient) based on the device information and Bluetooth beacon information that are collected by the Wi-Fi probe within the previous day. The persons counting phase include the actual number of persons passing through the target area within each time period of the day (e.g., per hour) using the Wi-Fi detection sampling rate of the previous day, that is, the verification coefficient.

Here, the criteria for determining that the Wi-Fi probe detects that the mobile phone application software reports the Bluetooth beacon are as follows: The time obtained by subtracting three minutes from the time the probe detects a person is less than the time the mobile phone application starts to report the last Bluetooth beacon, and time the mobile phone app ends reporting of the last Bluetooth beacon is less than the time that is obtained by adding three minutes to the time the probe stops detecting the person.

Further, the computer language used in the previous implementations can be C language, and hardware can include a Wi-Fi module and a Bluetooth module.

Further, in order to ensure cost-effectiveness, the sensor chip can be ESP32.

In some implementations, two different communication modes are used for cross detection, which improves the accuracy of using the first communication mode to detect the quantity of devices to determine the human traffic. In addition, the cloud data is encrypted before being delivered, so as to avoid uploading the MAC address, and only the final result will be uploaded. Therefore, the data result can be calculated on the cloud, and the privacy problem of Wi-Fi detection can be mitigated.

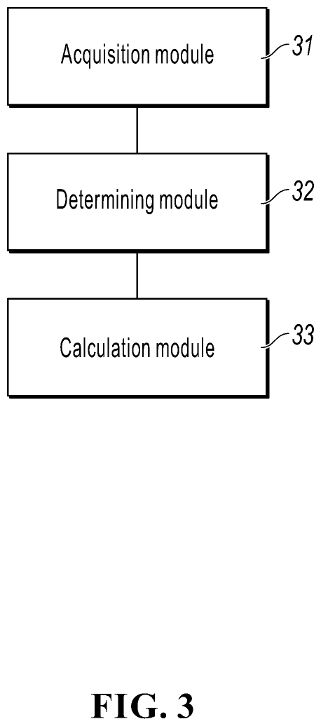

FIG. 3 is a schematic structural diagram of a human traffic statistical device, according to an implementation of the present disclosure. As shown in FIG. 3, the human traffic statistics device provided in some implementations of the present disclosure includes an acquisition module 31, a determining module 32, and a calculation module 33.

The acquisition module 31 is configured to obtain first device information of devices detected in a first communication mode in a target area.

The determining module 32 is configured to determine a first quantity of the devices in the target area based on the first device information.

The calculation module 33 is configured to: calculate a second quantity of the devices in the target area based on the first quantity and a verification coefficient, where the verification coefficient is obtained by detecting second device information in a second communication mode; and use the second quantity as real-time human traffic in the target area.

In an implementation of the present disclosure, the acquisition module 31 includes a first acquisition submodule and a second acquisition submodule; and the calculation module 33 includes a calculation submodule; where the first acquisition submodule is configured to obtain first device information of devices detected in a first communication mode in the target area; the second acquisition submodule is configured to obtain second device information of devices detected in a second communication mode in the target area; and the calculation submodule is configured to calculate the verification coefficient based on the first historical device information and the second historical device information.

In an implementation of the present disclosure, the calculation submodule is configured to: determine a third quantity of the same device identifiers in the first historical device information and the second historical device information based on the first historical device information and the second historical device information; and calculate the verification coefficient based on the third quantity and a fourth quantity extracted from the second historical device information.

In an implementation of the present disclosure, the first acquisition submodule is specifically configured to: obtain the first historical device information of the devices detected in the target area in a same period in the previous cycle in the first communication mode; and the second acquisition submodule is specifically configured to: obtain the second historical device information of the devices detected in the target area in the same period in the previous period in the second communication mode.

In an implementation of the present disclosure, the determining module 32 is further configured to: based on the first device information, count a fifth quantity of the devices detected at least twice within a predetermined period; and de-weight the devices in the target area based on the first quantity, to determine the first quantity of the devices in the target area.

In an implementation of the present disclosure, the device further includes: an encryption module, configured to encrypt a device address in the second history device information.

The device shown in FIG. 7 in some implementations of the present disclosure is an implementation device of the methods shown in FIG. 1 and FIG. 2 in the implementations of the present disclosure. A specific principle of the device is the same as that of the methods shown in FIG. 1 and FIG. 2 in the implementations of the present disclosure. Details are omitted here.

In an implementation of the present disclosure, a storage medium is further provided, where the storage medium stores computer program instructions, and the computer program instructions are executed according to the method of the present disclosure.

In a typical configuration of the present disclosure, a computing device includes one or more processors (CPUs), input/output interfaces, network interfaces, and memory.

The memory can include a non-persistent memory, a random access memory (RAM), and/or a non-volatile memory, for example, a read-only memory (ROM) or a flash memory (flash RAM). The memory is an example of the computer readable medium.

In an implementation of the present disclosure, a computing device is provided, including: a memory, configured to store computer program instructions, and a processor, configured to execute the computer program instructions, where when the computer program instructions are executed by the processor, the computing device is triggered to perform the method of the present disclosure.

The computer readable medium includes persistent, non-persistent, movable, and unmovable media that can store information by using any method or technology. The information can be a computer readable instruction, a data structure, a program device, or other data. Examples of the computer storage medium include but are not limited to a phase change random access memory (PRAM), a static random access memory (SRAM), a dynamic random access memory (DRAM), another type of RAM a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible to a computing device.

It has to be aware of that the present disclosure can be implemented by software and/or a combination of software and hardware, for example, using an application specific integrated circuit (ASIC), a general purpose computer, or any other similar hardware device. In some implementations, the software program of the present disclosure can be executed by a processor to implement the previous steps or functions. Similarly, the software program of the present disclosure (including a related data structure) can be stored in a computer readable recording medium, such as a RAM, a magnetic or optical drive, a floppy disk and other similar devices. In addition, some of the steps or functions of the present disclosure can be implemented by hardware, for example, as a circuit that cooperates with the processor to perform various steps or functions.

It is clear to a person skilled in the art that the present disclosure is not limited to the details of the example implementations described above, and that the present disclosure can be implemented in other specific forms without departing from the spirit or basic features of the present disclosure. Therefore, from any point of view, the implementations should be considered examples but not limitations, and the scope of the present disclosure is limited by the appended claims rather than the previous description, so that all changes that fall within the meaning and scope of the equivalents of the claims are intended to be encompassed within the present disclosure. Any reference numerals in the claims shall not be construed as limiting the claims to which they relate. In addition, it is clear that the term “include” does not preclude other units or steps, and a singular form does not preclude a plural form. The plurality of units or devices described in the claims of the device can also be implemented by a unit or device by using software or hardware. Words such as “first” and “second” are used to represent names rather than any particular order.

1. A computer-implemented method, comprising:
detecting, during a first time period, using a first wireless module based on a first wireless technology, a first set of devices in a target area, and collecting first device information of the first set of devices;
determining, based on the first device information, a first quantity of devices in the target area;
emitting, during a second time period occurring before the first time period, using a second wireless module based on a second wireless technology distinct from the first wireless technology, a wireless signal in the target area;
obtaining second device information of a second set of devices in the target area during the second time period, the second set of devices having received the wireless signal;
detecting, during the second time period, using the first wireless module based on the first wireless technology, a third set of devices in the target area, and collecting third device information of the third set of devices;
calculating a verification coefficient based on the second device information and the third device information; and
adjusting the first quantity of devices using the verification coefficient, to obtain a measure of real-time device traffic in the target area.

2. (canceled)

3. The computer-implemented method of claim 1, wherein the third device information comprises a first set of device identifiers corresponding, respectively, to each device in the third set of devices,
wherein the second device information comprises a second set of device identifiers corresponding, respectively, to each device in the second set of devices, and
wherein calculating the verification coefficient comprises:
determining a common quantity of device identifiers common to both the first set of device identifiers and the second set of device identifiers;
determining a second quantity of devices in the second set of devices; and
calculating the verification coefficient based on the common quantity and the second quantity.

4. The computer-implemented method of claim 1, wherein the first time period is a predetermined time period of a current time cycle, and
wherein the second time period is the predetermined time period of a previous time cycle.

5. The computer-implemented method of claim 1, wherein each device of the second set of devices transmits a notification to a cloud server responsive to receiving the wireless signal, and
wherein obtaining the second device information comprises:
collecting the second device information from a server remote from the target area.

6. The computer-implemented method of claim 1, wherein determining the first quantity of devices in the target area comprises:
counting, based on the first device information, a fourth quantity of devices detected at least twice within a predetermined period; and
de-weighting, based on the fourth quantity of devices, a total number of devices detected in the target area, to determine the first quantity of devices in the target area.

7. A non-transitory, computer-readable medium storing one or more instructions executable by a computer system to perform operations comprising:
detecting, during a first time period, using a first wireless module based on a first wireless technology, a first set of devices in a target area, and collecting first device information of the first set of devices;
determining, based on the first device information, a first quantity of devices in the target area;
emitting, during a second time period occurring before the first time period, using a second wireless module based on a second wireless technology distinct from the first wireless technology, a wireless signal in the target area;
obtaining second device information of a second set of devices in the target area during the second time period, the second set of devices having received the wireless signal;
detecting, during the second time period, using the first wireless module based on the first wireless technology, a third set of devices in the target area, and collecting third device information of the third set of devices;
calculating a verification coefficient based on the second device information and the third device information; and
adjusting the first quantity of devices using the verification coefficient, to obtain a measure of real-time device traffic in the target area.

8. (canceled)

9. The computer-readable medium of claim 7, wherein the third device information comprises a first set of device identifiers corresponding, respectively, to each device in the third set of devices,
wherein the second device information comprises a second set of device identifiers corresponding, respectively, to each device in the second set of devices, and
wherein calculating the verification coefficient comprises:
determining a common quantity of device identifiers common to both the first set of device identifiers and the second set of device identifiers;
determining a second quantity of devices in the second set of devices; and
calculating the verification coefficient based on the common quantity and the second quantity.

10. The computer-readable medium of claim 7, wherein the first time period is a predetermined time period of a current time cycle, and
wherein the second time period is the predetermined time period of a previous time cycle.

11. The computer-readable medium of claim 7, wherein each device of the second set of devices transmits a notification to a cloud server responsive to receiving the wireless signal, and
wherein obtaining the second device information comprises:
collecting the second device information from a server remote from the target area.

12. The computer-readable medium of claim 7, wherein determining the first quantity of devices in the target area comprises:
counting, based on the first device information, a fourth quantity of devices detected at least twice within a predetermined period; and
de-weighting, based on the fourth quantity of devices, a total number of devices detected in the target area, to determine the first quantity of devices in the target area.

13. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
detecting, during a first time period, using a first wireless module based on a first wireless technology, a first set of devices in a target area, and collecting first device information of the first set of devices;
determining, based on the first device information, a first quantity of devices in the target area;
emitting, during a second time period occurring before the first time period, using a second wireless module based on a second wireless technology distinct from the first wireless technology, a wireless signal in the target area;
obtaining second device information of a second set of devices in the target area during the second time period, the second set of devices having received the wireless signal;
detecting, during the second time period, using the first wireless module based on the first wireless technology, a third set of devices in the target area, and collecting third device information of the third set of devices;
calculating a verification coefficient based on the second device information and the third device information; and
adjusting the first quantity of devices using the verification coefficient, to obtain a measure of real-time device traffic in the target area.

14. (canceled)

15. The computer-implemented system of claim 13, wherein the third device information comprises a first set of device identifiers corresponding, respectively, to each device in the third set of devices,
wherein the second device information comprises a second set of device identifiers corresponding, respectively, to each device in the second set of devices, and
wherein calculating the verification coefficient comprises:
determining a common quantity of device identifiers common to both the first set of device identifiers and the second set of device identifiers;
determining a second quantity of devices in the second set of devices; and
calculating the verification coefficient based on the common quantity and the second quantity.

16. The computer-implemented system of claim 13, wherein the first time period is a predetermined time period of a current time cycle, and
wherein the second time period is the predetermined time period of a previous time cycle.

17. The computer-implemented system of claim 13, wherein each device of the second set of devices transmits a notification to a cloud server responsive to receiving the wireless signal, and
wherein obtaining the second device information comprises:
collecting the second device information from a server remote from the target area.

18. The computer-implemented system of claim 13, wherein determining the first quantity of devices in the target area comprises:
counting, based on the first device information, a fourth quantity of devices detected at least twice within a predetermined period; and
de-weighting, based on the fourth quantity of devices, a total number of devices detected in the target area, to determine the first quantity of devices in the target area.

19. The computer-implemented method of claim 5, wherein the second device information is encrypted.

20. The computer-implemented method of claim 5, wherein the second device information comprises a dictionary mapping device identifiers of the second set of devices to corresponding times at which each device of the second set of devices is detected in the target area.

21. The computer-implemented method of claim 1, wherein the first wireless technology comprises Wi-Fi, and wherein the second wireless technology comprises Bluetooth.
